(19) United States
(12) Patent Application Publication
(10) Pub. No.: US 2007/0090151 A1
(43) Pub. Date: Apr. 26, 2007

(54) Welding head with heat-conducting structure for a gas welding gun

(75) Inventors: Tomy Lin, Taichung (TW); Kevin Lin, Taichung (TW)

Correspondence Address: CHARLES E. BAXLEY, ESQ., 90 JOHN STREET, THIRD FLOOR, NEW YORK, NY, 10038, US

(73) Assignee: Pro-Aries Industries, Inc.

(21) Appl. No.: 11/255,318

(22) Filed: Oct. 20, 2005

(51) Int. Cl. B23K 1/00

(52) U.S. Cl. 228/25

(57) ABSTRACT

A welding head with heat-conducting structure for a gas welding gun comprises: a housing, a welding head and a non-flat net-like heating member. The housing is formed with a recess and a plurality of air holes in communication with the recess. The welding head is installed on the housing and formed with a guiding slope being located correspondingly to the air holes of the housing, and between the guiding slope and the air holes of the housing is formed a space. The non-flat net-like heating member received in the recess of the housing. The heating effect of the heating member is substantially increased by improving the contacting area. The heat produced during gas combustion will be discharged via the air holes and then guided to flow in the direction of the guide slope, and thus it can be prevented from damaging the neighboring electronic components.

### BACKGROUND OF THE INVENTION

1. Field of the Invention

The present invention relates to a product of gas welding gun, and more particularly to a welding head with heat-conducting structure for a gas welding gun.

2. Description of the Prior Art

Referring to FIG. 1, which shows a conventional gas welding gun comprising a gas container 11, a housing 12, an adjusting disc 13, a switch 14, a gas nozzle 15 and a welding head 16. As shown in FIG. 2, in the welding head 16 is formed a receiving recess 161 and an air hole 162 in communication with the receiving recess 161. In the receiving recess 161 are arranged three net-like heating members 163, when the mixture of gas and air is burned in the welding head 16, the heating members 163 will be heated to a very high temperature. And thus the welding head 16 is maintained at a high temperature for facilitating a welding operation. The heat or hot air A produced by the flaming gas can be discharged from the air hole 162. However, this conventional gas welding gun still has the following disadvantages:

First, due to the heating members 163 in the welding head 16 are in the form of a flat sheet, the contacting area of the heating members 163 with respect to the mixture of gas and air will be small, and accordingly, the heat energy that can be produced and conducted by the heating members 163 will be limited. Besides, the heating members 163 in the receiving recess 161 are arranged in parallel, this will adversely affect the gas and air flux inside the welding head 16, and as a result, the heating efficient of the heating members 163 will be decreased.

Second, the gas-combustion-produced hot air A is discharged from the air hole 162, plus electronic components nowadays are always arranged in a compact fashion, the discharge of hot air A will probably cause damage to neighboring electronic components.

The present invention has arisen to mitigate and/or obviate the afore-described disadvantages.

### SUMMARY OF THE INVENTION

The primary objective of the present invention is to provide a welding head for a gas welding gun, wherein the heating effect of the heating member is substantially increased by improving the contacting area.

The secondary objective of the present invention is to provide a welding head for a gas welding gun, wherein the heat produced during gas combustion will be discharged via the air holes and then guided to flow in the direction of the guide slope, and thus it can overcome the conventional problem of damaging the neighboring electronic components.

A welding head with heat-conducting structure for a gas welding gun provided by the present invention comprises:

a housing formed with a recess and a plurality of air holes in communication with the recess;

a welding head being installed on the housing and formed with a guiding slope located correspondingly to the air holes of the housing, and between the guiding slope and the air holes of the housing being formed a space; and

a non-flat net-like heating member received in the recess of the housing.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an assembly view of a conventional gas welding gun;

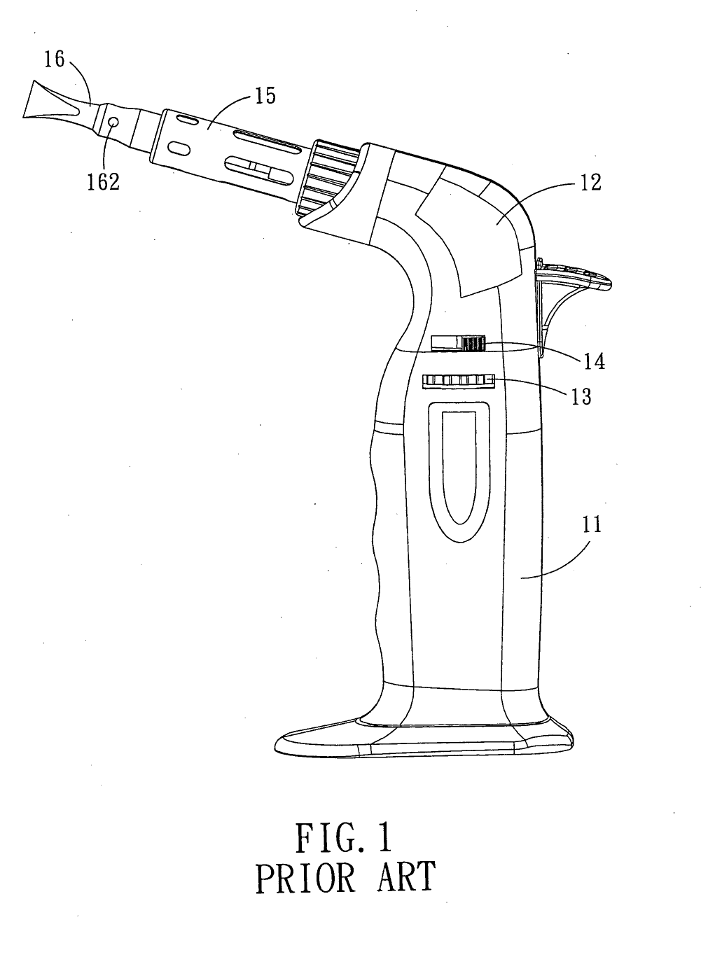

FIG. 2 is a cross sectional view of a welding head of the conventional gas welding gun in FIG. 1;

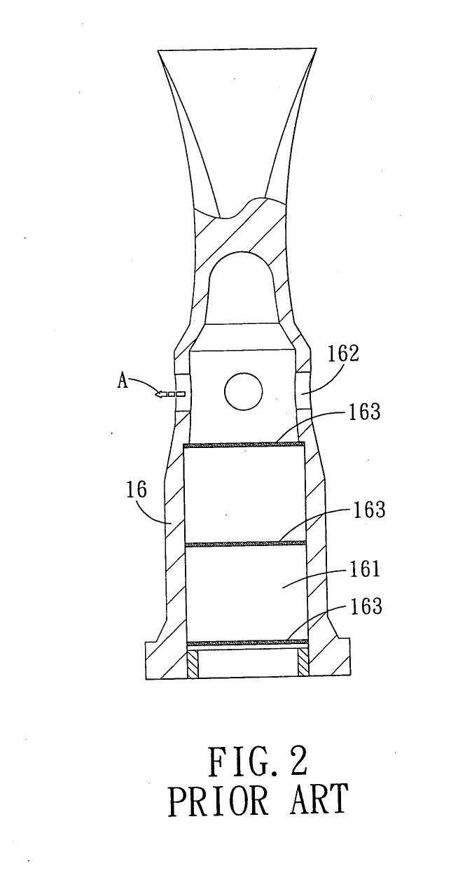

FIG. 3 is an exploded view of a welding head of a gas welding gun in accordance with the present invention; and

FIG. 4 is a cross sectional view of the welding head of a gas welding gun in accordance with the present invention.

### DETAILED DESCRIPTION OF THE PREFERRED EMBODIMENTS

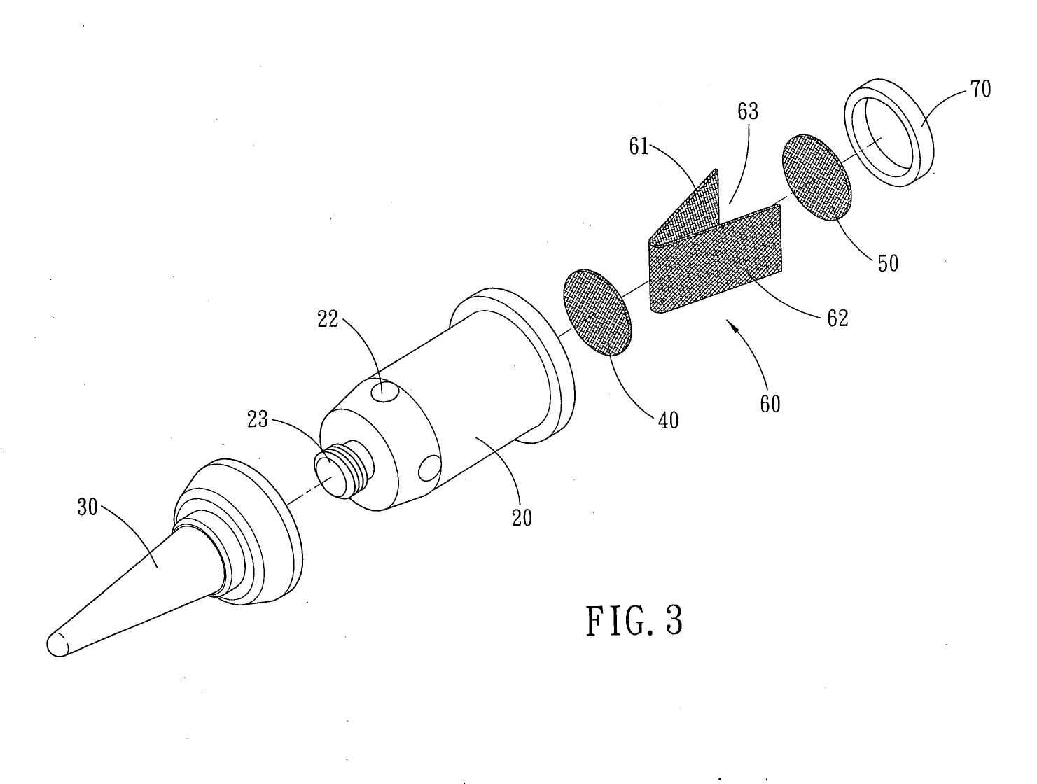

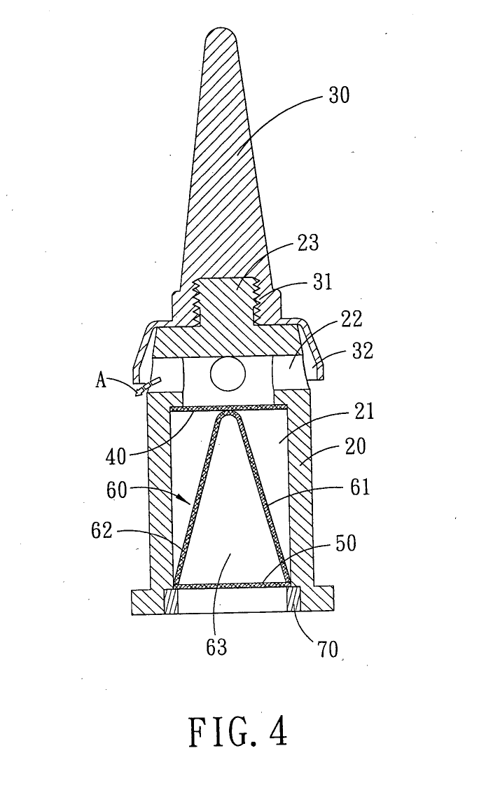

Referring to FIGS. 3 and 4, a welding head with heating-conducting structure for a gas welding gun in accordance with a preferred embodiment of the present invention is shown and comprises: a housing 20, a welding head 30, a tin net 40, a first net like heating member 50, a second net like heating member 60 and a positioning ring 70.

The housing 20 is formed with a recess 21 and four air holes 22 in communication with the recess 21. At an end of the housing 20 is formed a threaded portion 23.

The welding head 30 is cone shaped and has a threaded hole 31 to be screwed with the threaded portion 23 of the housing 20. The welding head 30 is further formed with a guiding slope 32 that is located correspondingly to the air holes 22 of the housing 20, and the space is left between the guiding slope 32 and the air holes 22 of the housing 20.

The tin net 40 is a flat net-like sheet received in the recess 21 of the housing 20.

The first net like heating member 50 is a flat sheet disposed at the entrance of the recess 21 of the housing 20.

The second net like heating member 60 is a non-flat sheet disposed in the recess 21 of the housing 20 and located between the first net like heating member 50 and the tin net 40. The second net like heating member 60 is formed by folding a rectangular sheet into a first reacting portion 61 and a second reacting portion 62, and between the first and second portions 61 and 62 is formed a gap 63 facing toward the entrance of recess 21 of the housing 20. The conjunction between the first and second portions 61 and 62 contacts the inner wall of the recess 21.

The positioning ring 70 is located at the entrance of the recess 21 of the housing 20 and serves to prevent the disengagement of the tin net 40, the first and second heating members 50 and 60 out of the recess 21.

When the gas and the air in the housing 20 is ignited to burn the first and second heating members 50 and 60, and with the continuous combustion of the gas, the welding head 30 will be heated to and maintained at a high temperature. And thus, a welding operation can be carried out.

The heat energy or hot air A produced in the gas combustion process will be discharged from the air holes 22. During the discharge of the heat air A, the heat air A will flow to the guiding slope 32 of the welding head 30, and the heat air will then be guided to flow in the direction of the guide slope 32. Meanwhile, the heat energy of the heat air A will be transmitted to the guiding slope 32, and thus the heat energy produced by the first and second heating members 50 and 60 is fully utilized. Therefore, the welding head of the present invention has high heat-conductivity, and also can overcome the conventional problem of damaging the neighboring electronic components.

In addition, the second heating member 60 is a non-flat structure disposed in the recess 21 of the housing 20, the contacting area of the heating members with respect to the mixture of gas and air will be effectively increased as compared to the conventional art, and thus improving the heating efficient of the first and second heating members 50 and 60. Due to the second heating member 60 is folded into a first reacting portion 61 and a second reacting portion 62, the area of the surface of the second heating member 60 is increased, and thus improving the heating efficient of the second heating member 60.

Due to the contacting area of the heating members with respect to the mixture of gas and air is increased, the flux of the mixture of gas and air flowing through the second heating member 60 is increased, this also can help improving the heating efficient of the second heating member 60.

While we have shown and described various embodiments in accordance with the present invention, it should be clear to those skilled in the art that further embodiments may be made without departing from the scope of the present invention.

What is claimed is:

1. A welding head with heat-conducting structure for a gas welding gun comprising:
a housing formed with a recess and a plurality of air holes in communication with the recess;
a welding head being installed on the housing and formed with a guiding slope located correspondingly to the air holes of the housing, and between the guiding slope and the air holes of the housing being formed a space; and
a non-flat net-like heating member received in the recess of the housing.

2. The welding head with heat-conducting structure for a gas welding gun as claimed in claim 1, wherein the heating member has a first reacting portion and a second portion, and between the first reacting portion and the second reacting portion is formed a gap that faces an entrance of the recess of the housing.

3. The welding head with heat-conducting structure for a gas welding gun as claimed in claim 1, wherein the heating member has a first reacting portion and a second portion, and a conjunction between the first reacting portion and the second reacting portion contacts an inner wall of the recess of the housing.

4. The welding head with heat-conducting structure for a gas welding gun as claimed in claim 1, wherein a threaded portion is formed on the housing, and on the welding head is formed a threaded hole to be screwed with threaded portion of the housing.
